(19) United States
(12) Patent Application Publication
(10) Pub. No.: US 2014/0279058 A1
(43) Pub. Date: Sep. 18, 2014

(54) CAPACITY CALCULATOR

(71) Applicant: GROUPON, INC., Chicago, IL (US)

(72) Inventors: Brian John Mullins, Chicago, IL (US); Stephen Michael Lang, Chicago, IL (US)

(73) Assignee: Groupon, Inc., Chicago, IL (US)

(21) Appl. No.: 13/830,243

(22) Filed: Mar. 14, 2013

(51) Int. Cl. G06Q 30/02

(52) U.S. Cl. CPC G06Q 30/0276
USPC 705/14.72

(57) ABSTRACT

Embodiments of the present invention provide systems, methods and computer readable media for calculating the capacity of a provider by calculating, using biographical data representing the provider, a first total units of service that are available to be offered to consumers during a first time period; calculating a second total units of service potentially available from the provider for a proposed second time period using a projection based in part on a model of consumer demand for the units of service; determining a third total units of service that are unavailable during the second time period based on at least one known or projected unavailability; and calculating a capacity based on the third total units of service and the second total units of service, the capacity being a capacity for a proposed promotion representing a maximum total of instruments to be offered in the proposed promotion by the provider.

### FIELD OF THE INVENTION

Embodiments of the invention relate, generally, to systems and methods for promotion capacity planning for providers.

### BACKGROUND OF THE INVENTION

Current methods for determining the capacity of a promotion (i.e., the maximum number of instruments for a provider to offer in a promotion) exhibit a plurality of problems that make current systems insufficient, ineffective and/or the like. Through applied effort, ingenuity, and innovation, solutions to improve such methods have been realized and are described in connection with embodiments of the present invention.

### BRIEF SUMMARY OF THE INVENTION

In general, embodiments of the present invention provide herein systems, methods and computer readable media for calculating the capacity of a provider by calculating, using biographical data representing attributes of the provider, a first total units of service that are available to be offered to consumers during a first time period; calculating a second total units of service potentially available from the provider for a proposed second time period using a projection based in part on the first total units of service and a model of consumer demand for the units of service; determining a third total units of service that are unavailable during the second time period based on one or more of a known unavailability or projected unavailability; and calculating a capacity based on the third total units of service and the second total units of service, wherein the capacity is a capacity for a proposed promotion representing a maximum total of instruments to be offered in the proposed promotion by the provider.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates an example system that can be configured as a tool to implement a calculation of a promotion capacity in accordance with some embodiments discussed herein;

FIG. 2 is a flow diagram of an example method for calculating the capacity of a proposed promotion in accordance with some embodiments discussed herein;

FIG. 3 is a flow diagram of an example method for calculating a total of units of service that the provider potentially will have available to offer through discount instruments during the time of promotion availability in accordance with some embodiments discussed herein;

FIG. 4 illustrates a graph of exemplary redemption curves representing promotions that all had a 6 month time of promotion availability (i.e. promotions that expired in 6 months) and that all had an overall instrument redemption rate of 80% or higher in accordance with some embodiments discussed herein;

FIG. 5 is a flow diagram of an example method for calculating a maximum total of instruments to be offered in a proposed promotion in accordance with some embodiments discussed herein; and

FIG. 6 illustrates a schematic block diagram of circuitry that can be included in a computing device, such as a capacity calculator, in accordance with some embodiments discussed herein.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like. Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, and/or the like.

The capacity of a promotion is the maximum number of instruments that a provider can offer to consumers during the time that the promotion is available. An important part of planning a new promotion is to choose a capacity that will deliver the optimum amount of new business to the provider without creating more business than the provider has resources to handle.

The systems and methods described herein are configured to calculate an optimum capacity for a proposed promotion. In some example embodiments, the maximum total of instruments that a provider potentially could offer during the availability time period is determined based on biographical data collected from the provider. This total is then adjusted using a model of consumer demand for a proposed promotion that is based on historical data representing consumer demand for instruments that were offered during the promotion availability time of similar promotions that now have expired. In some embodiments, this model is at least one redemption curve. The total is further adjusted by subtracting a total of outstanding instruments being offered currently by the provider. In various embodiments, the determination of whether outstanding instruments are being offered currently by a provider is based on searching one or more repositories of currently active promotions to discover whether the provider is offering any of those promotions and/or apply web scraping techniques to analyze published online content (e.g. websites and blogs) to discover active promotions from the provider.

FIG. 1 illustrates an example system 100 that can be configured as a tool to implement a calculation of a promotion capacity (i.e., the maximum number of instruments for a provider to offer in a promotion). In embodiments, the system 100 comprises a provider data collector 110 for receiving data describing attributes of a provider's business (provider biographical data, hereinafter) that are relevant to the type of service to be provided in a promotion instrument and for calculating, based on the received data, how many units of service the provider's business can provide to customers within a predetermined period of time; an available service calculator 120 for determining how many units of service the provider's business potentially can supply within the period of time during which the promotion instruments are offered (the promotion availability, hereinafter); and a promotion capacity calculator 130 for calculating the promotion capacity by determining a total of outstanding instruments currently being offered by the provider and subtracting that total from the total number of units of service that the provider potentially can supply.

FIG. 2 is a flow diagram of an example method 200 for calculating the capacity of a proposed promotion. For convenience, the method 200 will be described with respect to a system that includes one or more computing devices and performs the method 200. Specifically, the method 200 will be described with respect to system 100.

In embodiments, the system 100 receives 205 data describing a proposed promotion 105 for a number of redeemable instruments to be offered to consumers by a provider. Each promotion instrument represents a unit of service to be provided by the provider to the consumer at a discount when the instrument is redeemed. As used herein, the terms “service” and “unit of service” may refer to providing a specific item or items (e.g. a bouquet of flowers, a meal at a restaurant), providing a unit of work (e.g. a repair, a massage), providing an experience (e.g. guided travel, a yoga session), and/or the like. In embodiments, a particular proposed promotion is defined in terms of a promotion structure that includes the service to be offered, the number of instruments to be offered, the full value of the service, the discount price being offered, and the time period during which the promotion will be offered (time of promotion availability, hereinafter).

In embodiments, the system 100 receives 210 provider biographical data 115 through an interface provided by the provider data collector 110. In some embodiments, the interface is a graphical user interface (GUI) displayed on a client device. The GUI design may include a variety of data input widgets that receive user selections such as, for example, drop down menus and/or selection boxes displaying multiple choices. Alternatively, in some embodiments, the interface design is a form that provides a layout of data input fields.

In embodiments, at least a portion of the provider biographical data 115 being collected is related to attributes of the particular service being offered in the promotion. For example, a day spa may propose a promotion for a discounted full body massage, which is one type of service provided by the spa. In embodiments, the interface is designed to include questions for the provider that refer to general attributes of the business as well as to attributes specifically related to the service planned to be offered in the promotion. Example questions displayed in the day spa input interface include how many hours per week is the provider open for business, how many employees are available to perform the service per day, how many employees are required to perform a unit of service (e.g. the full body massage), and what is the average time spent in providing the unit of service.

In embodiments, the system 100 uses the provider biographical data 115 to calculate 215 the total number of units of service that the provider potentially can have available to offer within a pre-determined period of time. This total is calculated by determining, based on a time cost, the potential maximum number of units of service that the provider can provide during the period of time and subtracting the actual number of units of service that the provider typically provides during that period. Referring to the day spa example, if the spa potentially can provide 100 full body massages per week and actually provides 50 massages per week, the spa could potentially offer a maximum of 50 instruments for massages per week of the time of promotion availability.

In embodiments, the system 100 calculates 220 a total of units of service that the provider potentially will have available to offer through discount instruments during the time of promotion availability. Since the business will be offering discount instruments that consumers will redeem during the promotion availability, the actual number of units of service the provider will be providing as a result of the promotion offering will be affected by the rate of instrument redemptions during that time. Thus, in embodiments, the system 100 calculates the predicted total of units of service that the provider potentially will have available based in part on a model of consumer demand for the instruments being offered in the potential promotion.

In embodiments, a model of consumer demand for a proposed promotion is based on historical data representing consumer demand for instruments that were offered during the promotion availability time of similar promotions that now have expired. In various embodiments, the system receives the historical data representing consumer demand for instruments as one or more redemption curves 125, which will be described in more detail with reference to method 300.

In embodiments, the system 100 determines whether there are any outstanding instruments currently being offered by the provider for the particular service to be offered in the proposed promotion. Outstanding instruments will affect the predicted total of units of service that the provider potentially will have available to offer, since the redemption of a instrument represents a unit of service that the provider actually will be providing. If the system 100 determines that there are outstanding instruments 135 currently being offered by the provider, the system 100 calculates 225 a total of those outstanding instruments.

In embodiments, the system 100 calculates 230 a maximum number of instruments 145 to be offered in the potential promotion (the promotion capacity hereinafter) by subtracting the total of outstanding instruments from the predicted total of available services. Turning to the example, if it is predicted that the day spa potentially can offer 500 instruments over the time of promotion availability and it is determined that there are 50 instruments currently outstanding, the potential promotion capacity will be set at 450 instruments.

FIG. 3 is a flow diagram of an example method 300 for calculating a total of units of service that the provider potentially will have available to offer through discount instruments during the time of promotion availability. For convenience, the method 300 will be described with respect to a system that includes one or more computing devices and performs the method 300. Specifically, the method 300 will be described with respect to processing by the available service calculator module 120 of system 100.

In embodiments, the system receives 305 a calculated total of units of service available from a provider for offering as instruments during a particular period of time (e.g. a total of units of service available for offering as instruments per week) and a promotion availability time period for a proposed promotion (e.g. 26 weeks).

As previously described with reference to method 200, the system receives 310 one or more redemption curves representing historical instrument redemption behavior of consumers during promotion availability. A redemption curve is a graph of historical data collected from expired promotions, and is a mapping of the relative number of consumer instrument redemptions measured at each of regular points in time over the time of the promotion availability.

FIG. 4 illustrates a graph of exemplary redemption curves representing promotions that all had a 6 month time of promotion availability (i.e. promotions that expired in 6 months) and that all had an overall instrument redemption rate of 80% or higher. The graph contains four separate curves; each of the curves represents historical data collected from multiple promotions all classified as being within the same business category 410. The points on a curve each represent the weekly percent of redemptions 430 of the total number of instruments offered in the promotions.

A redemption curve provides a model of how consumers redeem instruments. For example, all of the redemption curves illustrate that, in general, consumers do not redeem instruments at a constant rate. In general, the redemption rate tends to be greater during the beginning and ending weeks of promotion availability. Additionally or alternatively, a redemption curve can be used to model consumer redemption behavior with respect to the type of promotion category. In the example, there are variations in the shapes of particular curves even though all of the curves have a similar overall shape.

In embodiments, the system uses the received redemptions curves to model instrument redemption rates over the proposed promotion availability time period 420, and then to calculate 315 the total units of service available during the proposed promotion availability using that model and the received total of available units of service per time period.

FIG. 5 is a flow diagram of an example method 500 for calculating a maximum total of instruments to be offered in a proposed promotion. For convenience, the method 500 will be described with respect to a system that includes one or more computing devices and performs the method 500. Specifically, the method 500 will be described with respect to processing by the promotion capacity calculator module 130 of system 100.

In embodiments, the system receives 505 data representing a provider and a proposed total of instruments to be offered in a proposed promotion by that provider.

In embodiments, the system determines 510 a total of outstanding instruments for units of the proposed promotion service that are currently being offered by the provider. As previously described, each outstanding instrument represents a potential redemption necessitating the provider's providing of the promotion service, and this will reduce the proposed number of instruments to be offered by the provider in the proposed promotion.

In embodiments, a determination of a total of outstanding instruments offered by the provider can be made using one or a combination of several processes. For example, the system 100 may be configured to search one or more repositories of currently active promotions to discover whether the provider is offering any of those promotions and, if so, determine a total of outstanding instruments for the proposed service that are included in those promotions. Additionally or alternatively, the system may 100 may be configured to apply web scraping techniques to analyze published online content (e.g. websites and blogs) to discover active promotions from the provider for the proposed service.

In embodiments, the system calculates 515 a maximum total of instruments to be offered in the proposed promotion by subtracting the determined total of outstanding instruments from the proposed total of instruments to be offered in the proposed promotion.

FIG. 6 shows a schematic block diagram of circuitry 600, some or all of which may be included in, for example, capacity calculator system 100. As illustrated in FIG. 6, in accordance with some example embodiments, circuitry 600 can include various means, such as processor 602, memory 604, communications module 606, and/or input/output module 608. As referred to herein, “module” includes hardware, software and/or firmware configured to perform one or more particular functions. In this regard, the means of circuitry 600 as described herein may be embodied as, for example, circuitry, hardware elements (e.g., a suitably programmed processor, combinational logic circuit, and/or the like), a computer program product comprising computer-readable program instructions stored on a non-transitory computer-readable medium (e.g., memory 604) that is executable by a suitably configured processing device (e.g., processor 602), or some combination thereof.

Processor 602 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 6 as a single processor, in some embodiments processor 602 comprises a plurality of processors. The plurality of processors may be embodied on a single computing device or may be distributed across a plurality of computing devices collectively configured to function as circuitry 600. The plurality of processors may be in operative communication with each other and may be collectively configured to perform one or more functionalities of circuitry 600 as described herein. In an example embodiment, processor 602 is configured to execute instructions stored in memory 604 or otherwise accessible to processor 602. These instructions, when executed by processor 602, may cause circuitry 600 to perform one or more of the functionalities of circuitry 600 as described herein.

Whether configured by hardware, firmware/software methods, or by a combination thereof, processor 602 may comprise an entity capable of performing operations according to embodiments of the present invention while configured accordingly. Thus, for example, when processor 602 is embodied as an ASIC, FPGA or the like, processor 602 may comprise specifically configured hardware for conducting one or more operations described herein. Alternatively, as another example, when processor 602 is embodied as an executor of instructions, such as may be stored in memory 604, the instructions may specifically configure processor 602 to perform one or more algorithms and operations described herein, such as those discussed in connection with FIGS. 1-5.

Memory 604 may comprise, for example, volatile memory, non-volatile memory, or some combination thereof. Although illustrated in FIG. 6 as a single memory, memory 604 may comprise a plurality of memory components. The plurality of memory components may be embodied on a single computing device or distributed across a plurality of computing devices. In various embodiments, memory 604 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 604 may be configured to store information, data (including analytics data), applications, instructions, or the like for enabling circuitry 600 to carry out various functions in accordance with example embodiments of the present invention. For example, in at least some embodiments, memory 604 is configured to buffer input data for processing by processor 602. Additionally or alternatively, in at least some embodiments, memory 604 is configured to store program instructions for execution by processor 602. Memory 604 may store information in the form of static and/or dynamic information. This stored information may be stored and/or used by circuitry 600 during the course of performing its functionalities.

Communications module 606 may be embodied as any device or means embodied in circuitry, hardware, a computer program product comprising computer readable program instructions stored on a computer readable medium (e.g., memory 604) and executed by a processing device (e.g., processor 602), or a combination thereof that is configured to receive and/or transmit data from/to another device, such as, for example, a second circuitry 600 and/or the like. In some embodiments, communications module 606 (like other components discussed herein) can be at least partially embodied as or otherwise controlled by processor 602. In this regard, communications module 606 may be in communication with processor 602, such as via a bus. Communications module 606 may include, for example, an antenna, a transmitter, a receiver, a transceiver, network interface card and/or supporting hardware and/or firmware/software for enabling communications with another computing device. Communications module 606 may be configured to receive and/or transmit any data that may be stored by memory 604 using any protocol that may be used for communications between computing devices. Communications module 606 may additionally or alternatively be in communication with the memory 604, input/output module 608 and/or any other component of circuitry 600, such as via a bus.

Input/output module 608 may be in communication with processor 602 to receive an indication of a user input and/or to provide an audible, visual, mechanical, or other output to a user. Some example visual outputs that may be provided to a user by circuitry 600 are discussed in connection with FIGS. 1-2. As such, input/output module 608 may include support, for example, for a keyboard, a mouse, a joystick, a display, a touch screen display, a microphone, a speaker, a RFID reader, barcode reader, biometric scanner, and/or other input/output mechanisms. In embodiments wherein circuitry 600 is embodied as a server or database, aspects of input/output module 608 may be reduced as compared to embodiments where circuitry 600 is implemented as an end-user machine or other type of device designed for complex user interactions. In some embodiments (like other components discussed herein), input/output module 608 may even be eliminated from circuitry 600. Alternatively, such as in embodiments wherein circuitry 600 is embodied as a server or database, at least some aspects of input/output module 608 may be embodied on an apparatus used by a user that is in communication with circuitry 600, such as for example, pharmacy terminal 108. Input/output module 608 may be in communication with the memory 604, communications module 606, and/or any other component(s), such as via a bus. Although more than one input/output module and/or other component can be included in circuitry 600, only one is shown in FIG. 6 to avoid overcomplicating the drawing (like the other components discussed herein).

Capacity calculator module 610 may also or instead be included and configured to perform the functionality discussed herein related to the calculation of the capacity of a proposed promotion as discussed above. In some embodiments, some or all of the functionality of promotion capacity calculation may be performed by processor 602. In this regard, the example processes and algorithms discussed herein can be performed by at least one processor 602 and/or capacity calculator module 610. For example, non-transitory computer readable media can be configured to store firmware, one or more application programs, and/or other software, which include instructions and other computer-readable program code portions that can be executed to control each processor (e.g., processor 602 and/or capacity calculator module 610) of the components of system 100 to implement various operations, including the examples shown above. As such, a series of computer-readable program code portions are embodied in one or more computer program products and can be used, with a computing device, server, and/or other programmable apparatus, to produce machine-implemented processes.

As will be appreciated, any such computer program instructions and/or other type of code may be loaded onto a computer, processor or other programmable apparatus's circuitry to produce a machine, such that the computer, processor other programmable circuitry that execute the code on the machine create the means for implementing various functions, including those described herein.

It is also noted that all or some of the information presented by the example displays discussed herein can be based on data that is received, generated and/or maintained by one or more components of circuitry 600. In some embodiments, one or more external systems (such as a remote cloud computing and/or data storage system) may also be leveraged to provide at least some of the functionality discussed herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Embodiments of the present invention have been described above with reference to block diagrams and flowchart illustrations of methods, apparatuses, systems and computer program products. It will be understood that each block of the circuit diagrams and process flow diagrams, and combinations of blocks in the circuit diagrams and process flowcharts, respectively, can be implemented by various means including computer program instructions. These computer program instructions may be loaded onto a general purpose computer, special purpose computer, or other programmable data processing apparatus, such as processor 602 and/or capacity calculator module 610 discussed above with reference to FIG. 6, to produce a machine, such that the computer program product includes the instructions which execute on the computer or other programmable data processing apparatus create a means for implementing the functions specified in the flowchart block or blocks.

These computer program instructions may also be stored in a computer-readable storage device (e.g., memory 604) that can direct a computer or other programmable data processing apparatus to function in a particular manner, such that the instructions stored in the computer-readable storage device produce an article of manufacture including computer-readable instructions for implementing the function discussed herein. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions discussed herein.

Accordingly, blocks of the block diagrams and flowchart illustrations support combinations of means for performing the specified functions, combinations of steps for performing the specified functions and program instruction means for performing the specified functions. It will also be understood that each block of the circuit diagrams and process flowcharts, and combinations of blocks in the circuit diagrams and process flowcharts, can be implemented by special purpose hardware-based computer systems that perform the specified functions or steps, or combinations of special purpose hardware and computer instructions

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method, comprising:
calculating, using biographical data representing attributes of a provider offering particular units of service to consumers, a first total of the units of service that are determined to be available to be offered as redeemable instruments to consumers during a proposed promotion over a first time period;
calculating a second total of the units of service that are available from the provider during a second time period using a projection based in part on the first total of the units of service and a model of consumer demand for the units of service;
determining a third total of the units of service that are unavailable from the provider during the second time period based on one or more of a known unavailability or projected unavailability; and
calculating, by a processor, a capacity based on the third total of the units of service and the second total of the units of service, wherein the capacity represents a maximum total of redeemable instruments to be offered via a promotion and marketing service in the second time period in exchange for one or more of the units of service.

2. The method of claim 1, wherein the second time period is shorter than a proposed promotion availability time period during which the redeemable instruments will be offered to consumers by the provider in the proposed promotion, wherein the model of consumer demand for the units of service is a model of consumer demand for the redeemable instruments being offered in the proposed promotion, and wherein the third total is a total of the units of service represented as outstanding redeemable instruments currently being offered to consumers by the provider.

3. The method of claim 2, wherein calculating the second total of the units of service comprises:
receiving at least one redemption curve, wherein the redemption curve represents historical consumer instrument redemption behavior at points of time during a promotion availability time period of at least one expired promotion; and
calculating the second total of the units of service using the redemption curve.

4. The method of claim 3, wherein the redemption curve represents historical consumer instrument redemption behavior during the respective availability time periods of a group of expired promotions associated with a first promotion category.

5. The method of claim 4, wherein the proposed promotion is associated with the first promotion category.

6. The method of claim 3, wherein the redemption curve represents historical consumer instrument redemption behavior during the respective availability time periods of a group of promotions each associated with a first promotion structure.

7. The method of claim 6, wherein the proposed promotion is associated with the first promotion structure.

8. The method of claim 2, wherein determining the third total of the units of service comprises:
applying web scraping techniques to analyze published online content.

9. The method of claim 2, wherein determining the third total of the units of service comprises:
searching one or more repositories of currently active promotions to discover whether the provider is offering any of those promotions.

10. The method of claim 2, wherein the biographical data comprise a time cost for providing one of the units of service and wherein the first total of the units of service are calculated remote from the provider and the calculation is based solely on biographical data representing attributes of a provider.

11. A system comprising:
one or more computers and one or more storage devices storing instructions that are operable, when executed by the one or more computers, to cause the one or more computers to perform operations comprising:
calculating, using biographical data representing attributes of a provider offering particular units of service to consumers, a first total of the units of service that are determined to be available to be offered as redeemable instruments to consumers during a proposed promotion over a first time period;
calculating a second total of the units of service that are available from the provider during a second time period using a projection based in part on the first total of the units of service and a model of consumer demand for the units of service;
determining a third total of the units of service that are unavailable from the provider during the second time period based on one or more of a known unavailability or projected unavailability; and
calculating a capacity based on the third total of the units of service and the second total of the units of service, wherein the capacity represents a maximum total of redeemable instruments to be offered via a promotion and marketing service in the second time period in exchange for one or more of the units of service.

12. The system of claim 11, wherein the second time period is shorter than a proposed promotion availability time period during which the redeemable instruments will be offered to consumers by the provider in the proposed promotion, wherein the model of consumer demand for the units of service is a model of consumer demand for the redeemable instruments being offered in the proposed promotion, and wherein the third total is a total of the units of service represented as outstanding redeemable instruments currently being offered to consumers by the provider.

13. The system of claim 12, wherein calculating the second total of the units of service comprises:
receiving at least one redemption curve, wherein the redemption curve represents historical consumer instrument redemption behavior at points of time during a promotion availability time period of at least one expired promotion; and
calculating the second total of the units of service using the redemption curve.

14. The system of claim 13, wherein the redemption curve represents historical consumer instrument redemption behavior during the respective availability time periods of a group of expired promotions associated with a first promotion category.

15. The system of claim 14, wherein the proposed promotion is associated with the first promotion category.

16. The system of claim 13, wherein the redemption curve represents historical consumer instrument redemption behavior during the respective availability time periods of a group of promotions each associated with a first promotion structure.

17. The system of claim 16, wherein the proposed promotion is associated with the first promotion structure.

18. The system of claim 12, wherein determining the third total of the units of service comprises:
applying web scraping techniques to analyze published online content.

19. The system of claim 12, wherein determining the third total of the units of service comprises:
searching one or more repositories of currently active promotions to discover whether the provider is offering any of those promotions.

20. The system of claim 12, wherein the biographical data comprise a time cost for providing one of the units of service.

21. A computer program product, stored on a non-transitory computer readable medium, comprising instructions that when executed on one or more computers cause the one or more computers to perform operations comprising:
calculating, using biographical data representing attributes of a provider offering particular units of service to consumers, a first total of the units of service that are determined to be available to be offered as redeemable instruments to consumers during a proposed promotion over a first time period;
calculating a second total of the units of service that are available from the provider during a second time period using a projection based in part on the first total of the units of service and a model of consumer demand for the units of service;
determining a third total of the units of service that are unavailable from the provider during the second time period based on one or more of a known unavailability or projected unavailability; and
calculating a capacity based on the third total of the units of service and the second total of the units of service, wherein the capacity represents a maximum total of redeemable instruments to be offered via a promotion and marketing service in the second time period in exchange for one or more of the units of service.

22. The computer program product of claim 21, wherein the second time period is shorter than a proposed promotion availability time period during which the redeemable instruments will be offered to consumers by the provider in the proposed promotion, wherein the model of consumer demand for the units of service is a model of consumer demand for the redeemable instruments being offered in the proposed promotion, and wherein the third total is a total of the units of service represented as outstanding redeemable instruments currently being offered to consumers by the provider.

23. The computer program product of claim 22, wherein calculating the second total of the units of service comprises:
receiving at least one redemption curve, wherein the redemption curve represents historical consumer instrument redemption behavior at points of time during a promotion availability time period of at least one expired promotion; and
calculating the second total of the units of service using the redemption curve.

24. The computer program product of claim 23, wherein the redemption curve represents historical consumer instrument redemption behavior during the respective availability time periods of a group of expired promotions associated with a first promotion category.

25. The computer program product of claim 24, wherein the proposed promotion is associated with the first promotion category.

26. The computer program product of claim 23, wherein the redemption curve represents historical consumer instrument redemption behavior during the respective availability time periods of a group of promotions each associated with a first promotion structure.

27. The computer program product of claim 26, wherein the proposed promotion is associated with the first promotion structure.

28. The computer program product of claim 22, wherein determining the third total of the units of service comprises:
applying web scraping techniques to analyze published online content.

29. The computer program product of claim 22, wherein determining the third total of the units of service comprises:
searching one or more repositories of currently active promotions to discover whether the provider is offering any of those promotions.

30. The computer program product of claim 22, wherein the biographical data comprise a time cost for providing one of the units of service.
